(19) United States
(12) Patent Application Publication
(10) Pub. No.: US 2010/0121781 A1
(43) Pub. Date: May 13, 2010

(54) Mechanisms for illustrating the choices in an optimal solution to a set of business choices

(76) Inventor: Clifford James Berg, Reston, VA (US)

Correspondence Address: Clifford Berg, 2003 Cutwater Court, Reston, VA, 20191, US

(21) Appl. No.: 12/590,229

(22) Filed: Nov. 4, 2009

Related U.S. Application Data
(60) Provisional application No. 61/198,389, filed on Nov. 5, 2008.

(51) Int. Cl. G06Q 40/00; G06T 11/20

(52) U.S. Cl. 705/36 R; 345/440

(57) ABSTRACT

The invention consists of a means of illustrating how each investment in a portfolio of investments is expected to contribute to the total business value of the portfolio, subject to any overall investment budget constraint, while also showing the level of uncertainty around each expected value. This enables the investor to understand the contribution to total value provided by each investment, thereby enabling better decision-making about investments within a portfolio.

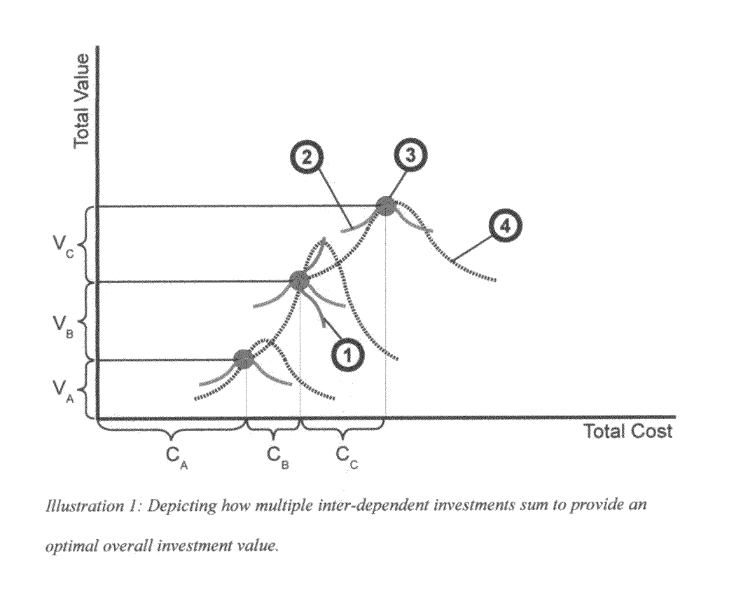

Investment return versus investment cost is plotted for each investment of the portfolio, and these are plotted in such as way as to see how each investment contributes to the overall portfolio's value. The uncertainty in the return may also optionally be plotted, as well as the uncertainty in the expected investment cost: these help the investor to gauge how these uncertainties affect overall portfolio uncertainty.

### BACKGROUND

Organizations have to make decisions about how they invest in information technology (IT). A decision, or a set of supporting decisions, can be considered to be a strategy.

The business value of a strategy is modeled as the sum of a set of variables, each with a statistical distribution. The variables may be inter-dependent, or independent.

The resulting total business value for an investment strategy can therefore be characterized as a statistical distribution. The mean of this distribution is the expected value of the strategy.

Finding the optimal investment strategy is often difficult, because the statistical distribution of each variable is often not known with certainty, or depends on key assumptions or decision factors. It is therefore useful to test assumptions and decision factors by adjusting them and seeing how they alter the expected overall business value.

### BRIEF SUMMARY OF INVENTION

The invention consists of a means of illustrating how each investment in a portfolio of investments is expected to contribute to the total business value of the portfolio, subject to any overall investment budget constraint, while also showing the level of uncertainty around each expected value. This enables the investor to understand the contribution to total value provided by each investment, thereby enabling better decision-making about investments within a portfolio.

### BRIEF DESCRIPTION OF ILLUSTRATIONS

Illustration 1: Depicts how multiple inter-dependent investments sum to provide an optimal overall investment value. This depiction is the essence of the invention: it enables one to see how each individual investment contributes to the total value of a portfolio of investments. It also shows the uncertainty associated with each investment. Finally, it shows that each individual investment is funded at a non-optimal level, even though the portfolio is optimal.

### DETAILED DESCRIPTION OF INVENTION

The purpose of this invention is to enable one to conveniently view how each variable affects the total business value, and to enable the user to receive immediate visual feedback on the change in value as assumptions are adjusted.

### Each Component Investment Has a Distribution

Illustration 1 shows how this works. In this illustration, a small vertically oriented solid line curve is depicted, labeled “1”. The curved line is capped by a shaded dot indicating the point of maximum of its curve, labeled “3”. The solid line curve represents a projected distribution of a random variable. This curve curve is a probability density distribution, with an implied horizontal axis (not shown) that is the probability density and the vertical axis (shown) that is the expected business value. The terms “expected value” and “probability density distribution” are standard terms in the field of statistics.

Illustration 1 depicts three investments in a portfolio of investments. Each investment has a curve similar to curve “1”, but the curve is only shown for investment B in order to avoid clutter in the diagram.

In addition, each investment has a horizontally oriented curve, representing the probability density of the cost of the investment. This type of curve is exemplified by item “2” in Illustration 1, but the illustration shows this type of curve for each investment.

The probability density curves indicate in tangible terms the uncertainties surrounding each investment of the portfolio. These uncertainties can be aggregated mathematically to compute uncertainties for the entire portfolio. That is not shown in the illustration however.

Each solid curve in the Illustration therefore represents a random variable that represents the value or cost of a particular investment. However, each of the value variables (V_{A}, V_{B}, and V_{C} in the illustration) also contributes to overall business value for the investor or organization: the total business value is the sum of these variables. That is, the total business value of a portfolio is the sum of the value of each investment in the portfolio. Similarly, each cost variable (C_{A}, C_{B}, and C_{C}) contributes to the total investment cost of the portfolio.

Choices (strategies) regarding each investment (such as how much to invest) alter the projected distribution of the investment's value. For each investment in Illustration 1, the dotted line curve (exemplified by curve “4”) shows how the projected expected value for that investment changes over the range of amount to invest (cost) for the investment. Each of these dotted line curves may have a maximum, representing the maximum possible expected value for that investment in isolation. It is not required that it have a maximum, however.¹ ¹ The reason that a dotted line curve might have a maximum is because unlimited investment usually produces diminishing returns so that cost starts to overwhelm the return.

### Component Investments are Often Inter-Dependent

If the investment value random variables are independent, then the optimal solution for the investor (the organization) is simply the solution that lies on the maximum of each dotted line curve.² However, in most investment situations, investments are not independent, because investment funds are limited and so investment in one area takes away from the others, and for investments that are internal to an organization there are often other inter-dependencies as well due to operational constraints. Thus, we are interested in finding the optimal investment amount for each investment, given that the total investment is limited to an overall portfolio investment budget. ² If any of the dotted line curves has no maximum, then the optimal investment is infinite.

### Aggregating the Multiple Investments

The interdependencies among investment choices can be modeled using many techniques, such as by using random (“stochastic”, or “Monte-Carlo”) simulation or by using “mathematical programming” to algorithmically compute an optimum. Regardless which technique is used, the optimum often involves investment choices that result in a sub-optimal expected value for each separate investment, but that results in an overall maximum for the total of these investments. This is shown in Illustration 1 by the fact that the three green dots are not on the maximum of each dotted line curve. Each dot represents an expected non-optimal value for each of the three investments, but the total of all three is maximized, given the constraints under which the investor (the organization) must operate. (A curve of total value is not shown in the FIGURE, but it could easily be by plotting the change in expected total value versus various investment choices.)

### The Organization's Budget

The total amount invested by the investor (the organization) is the total of what is invested in each component investment. In illustration 1, this is

C_{A}+C_{B}+C_{C}

This total must be less than or equal to the total funds available for investment: the organization's budget for investment. The investment criteria is therefore to maximize the sum of the expected value of each investment, subject to the total amount invested being within the budget. In mathematical terms, this is expressed as:

$$Maximize {\sum }_{i} {V}_{i} subject to {\sum }_{i} {C}_{i} \leq Budget$$

where Vᵢ is the value of investment i, and Cᵢ is the cost of investment i.

Illustration 1 has the advantage that it shows how the investments stack together to produce a composite investment portfolio for the investor (the organization).

How this View Can be Used

The type of view described here can be used in very powerful ways to perform “sensitivity analysis” on investment choices. For example:
1. Key assumptions can be adjusted, the maximization algorithm or simulation re-run, and the illustration updated (perhaps in real time) to show the impact.
2. Investment preferences, such as risk preferences, can be adjusted, and the results updated as in 1 above.
3. Decisions about individual investments can be adjusted to see the impact.
4. The optimal solution might indicate that investment in some components should be zero, indicating that they should be removed from the portfolio. Adjustments to assumptions or decisions might cause this result to change, putting those investments back in the portfolio. These changes can be observed using the type of view depicted by Illustration 1.

### REFERENCES

1. Real Options, by Copeland and Antikarov, copyright 2003.
2. Value-Driven IT, by Cliff Berg, copyright 2008.

The embodiments of the invention in which an exclusive property or privilege is claimed are defined as follows:

1. A depiction of a portfolio of potential investments (see Illustration 1), wherein:
a. The amount to be invested is plotted on one axis (the “cost” axis), and the amount realized (the profit, or net value) is plotted on the other axis (the “value” axis). These amounts are predicted values: they are based on future projections. As such, they have uncertainty associated with them, and the points plotted are “expected values”, according to the definition of a statistical expected value.
b. The plot of each investment is arranged so that once one investment is plotted, the other is plotted adjacent to it, rather than starting from the origin. That is, the point representing the investment cost and value for one investment serves as the origin for the next investment to be plotted. For example, in Illustration 1, investment A has a cost of C_{A} and a value of V_{A}, and investment B is plotted starting from point (C_{A}, V_{A}) rather that from point (0,0).
c. Once all investments have been plotted, the total cost and total value for the portfolio of investments can be seen by looking at the cost axis and value axis of the last investment plotted. For example, in Illustration 1, for the portfolio of three investments A, B, and C, the total cost for these three investments is indicated by the position of investment C on the cost axis, and the total value is similarly found by the position of investment C on the value axis.

2. The combination defined in claim 1, wherein a curve depicting the probability distribution (more precisely, the probability “density”) of the cost and/or value of an investment is super-imposed over the cost and value point, so that one can understand how uncertain the prediction of cost or value is. For example, in Illustration 1, each of the three investment points is super-imposed by a solid line curve: in each case the curve represents the probability distribution (density) for the predicted cost. An analogous curve could be shown, arranged vertically, for the predicted value of each investment point, but is not shown to avoid cluttering the diagram.

3. The combination defined in claim 1, wherein a curve depicting the expected value of each investment as a function of cost, is super-imposed on the investment point. For example, in Illustration 1, a dashed line curve is drawn over each investment point: this curve shows the value expected from the investment as a function of how much (cost) is invested. This is done for each of the three investments. This allows one to see and understand how sensitive the value received is to the amount invested, for each of the investments depicted.

4. The combination defined in claim 1, wherein the investment points are chosen so as to maximize the total value, given a fixed cost budget that is available to be invested.

5. The combination defined in claims 1 through 3, wherein one can interactively adjust an investment point and see the curves redrawn in real time.

6. The combination defined in claims 1, 2, and 4, wherein one can interactively adjust a probability curve, or adjust any parameters used to compute the probability curve, and see how the optimal investments, subject to a fixed cost budget, change, in real time.

7. The combination defined in claims 1, 3, and 4, wherein one can interactively adjust a curve of expected value, or any parameters used to compute the curve of expected value, and see how the optimal investments, subject to a fixed cost budget, change, in real time.

8. The combination defined in claims 1 and 4, wherein one can interactively adjust the fixed cost or budget, and see how the optimal investments, subject to that cost budget, change, in real time.
